(19) United States
(12) Patent Application Publication
(10) Pub. No.: US 2020/0064218 A1
(43) Pub. Date: Feb. 27, 2020

(54) PRESSURE DETECTING DEVICE

(71) Applicant: Hitachi Automotive Systems, Ltd., Hitachinaka-shi, Ibaraki (JP)

(72) Inventors: Hiroshi ONUKI, Ibaraki (JP); Daisuke TERADA, Ibaraki (JP); Takuya AOYAGI, Ibaraki (JP)

(73) Assignee: Hitachi Automotive Systems, Ltd., Hitachinaka-shi, Ibaraki (JP)

(21) Appl. No.: 16/466,160

(22) PCT Filed: Oct. 25, 2017
(86) PCT No.: PCT/JP2017/038451

§ 371 Date: Jun. 3, 2019

(30) Foreign Application Priority Data
Dec. 6, 2016 (JP) 2016-236406

(51) Int. Cl. G01L 19/00; G01D 11/24; G01L 7/08

(52) U.S. Cl. CPC G01L 19/0084; G01L 7/08; G01D 11/245

(57) ABSTRACT

There is provided a pressure detecting device whose number of connection points and number of parts are small.

A pressure detecting device 100 includes a sensor unit 30 which includes a strain detecting element which detects a strain amount of a pressure receiving surface 11p strained when receiving a pressure, and a processing circuit which processes a signal from the strain detecting element, and includes a housing 10 which houses the sensor unit 30, and terminals 20a and 20c which are connected to the sensor unit 30 and part of which is exposed retractably from the housing 10, and the terminals 20a and 20c include spring mechanisms 22a and 22c which are provided in the housing 10 and can elastically deform.

### TECHNICAL FIELD

The present invention relates to a pressure detecting device which detects a pressure.

### BACKGROUND ART

As a pressure detecting device which detects a brake hydraulic pressure of a vehicle, for example, a technique disclosed in PTL 1 is known. That is, PTL 1 discloses a pressure sensor in which a sensor chip, a connection member, an internal connection region, a plurality of mounting regions, an external connection region, a spring member, and a terminal are electrically connected in order.

### CITATION LIST

### Patent Literature

PTL 1: JP 2016-008842 A

### SUMMARY OF INVENTION

### Technical Problem

However, the technique disclosed in PTL 1 has a large number of connection points for electrically connecting each member and each region, and has a large number of parts.

It is therefore an object of the present invention to provide a pressure detecting device whose number of connection points and number of parts are small.

### Solution to Problem

To solve the above problem, a pressure detecting device according to the present invention includes: a sensor unit which includes a strain detecting element which detects a strain amount of a pressure receiving surface strained when receiving a pressure, and a processing circuit which processes a signal from the strain detecting element; a housing which houses the sensor unit; and a terminal which is connected to the sensor unit and part of which is exposed retractably from the housing, and the terminal includes a spring mechanism which is provided in the housing and can elastically deform.

### Advantageous Effects of Invention

According to the present invention, it is possible to provide a pressure detecting device whose number of connection points and number of parts are small.

### BRIEF DESCRIPTION OF DRAWINGS

FIG. 1A is a side view of a pressure detecting device according to a first embodiment of the present invention.

FIG. 1B is a plan view of the pressure detecting device according to the first embodiment of the present invention.

FIG. 2 is a cross-sectional view taken along a II-II line arrow view in FIG. 1B.

FIG. 3 is a cross-sectional view taken along a III-III line arrow view in FIG. 1B.

FIG. 4 is a partial enlarged view in a dashed-dotted line frame in FIG. 2.

FIG. 5A is a side view of a pressure port of the pressure detecting device according to the first embodiment of the present invention.

FIG. 5B is an end surface view taken along a V-V line arrow view in FIG. 5A.

FIG. 5C is a cross-sectional view taken along a VI-VI line arrow view in FIG. 5A.

FIG. 6A is a plan view of the pressure detecting device according to a second embodiment of the present invention.

FIG. 6B is a cross-sectional view taken along a II-II line arrow view in FIG. 6A.

FIG. 6C is a cross-sectional view taken along a III-III line arrow view in FIG. 6A.

FIG. 7 is an explanatory view illustrating a state where the pressure detecting device according to the second embodiment of the present invention is electrically connected with a substrate.

FIG. 8A is a plan view of the pressure detecting device according to a modification of the present invention.

FIG. 8B is a side view of an upper portion of the pressure detecting device according to the modification of the present invention.

FIG. 9A is a plan view of the pressure detecting device according to another modification of the present invention.

FIG. 9B is a side view of an upper portion of the pressure detecting device according to another modification of the present invention.

### DESCRIPTION OF EMBODIMENTS

### First Embodiment

### <Configuration of Pressure Detecting Device>

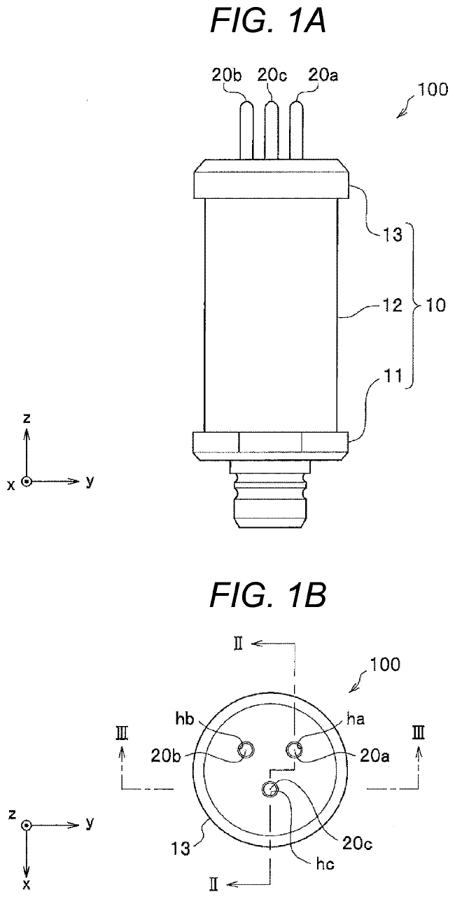

FIG. 1A is a side view of a pressure detecting device 100 according to the first embodiment.

In addition, x, y, and z axes are defined as illustrated in FIG. 1A. Furthermore, a positive side of the z axis is referred to as an “upper side”, and a negative side is referred to as a “lower side” for the sake of convenience.

The pressure detecting device 100 is a device which detects a pressure of a pressure medium, and is used to, for example, detect a brake hydraulic pressure of a brake actuator of a vehicle. In addition, the above-described “pressure medium” is not limited to a liquid and includes a gas, too.

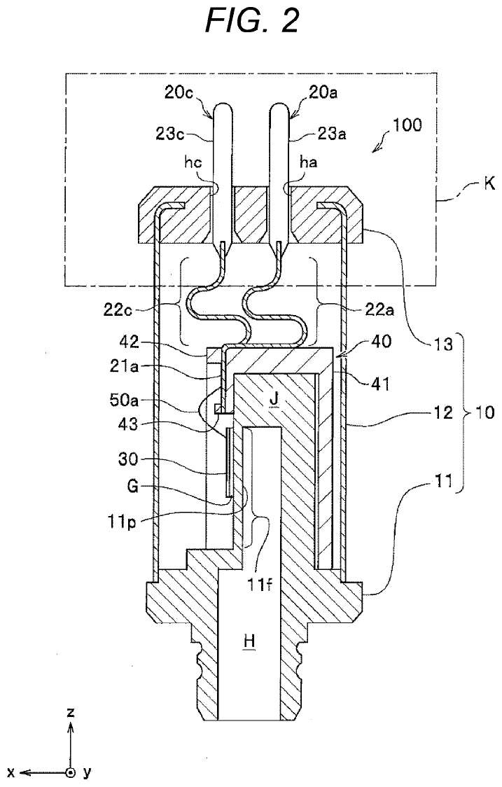

As illustrated in FIG. 1A, the pressure detecting device 100 includes a housing 10 which houses a sensor unit 30 (see FIG. 2), and terminals 20a, 20b, and 20c which are electrically connected to an external substrate (not illustrated). The above-described substrate is installed in, for example, an ECU (Electronic Control Unit) of the vehicle.

The housing 10 includes a pressure port 11 in which the pressure medium is introduced, a cover 12 of a cylindrical shape, and a guide 13 in which the terminals 20a, 20b, and 20c are inserted. In addition, a configuration of each member of the housing 10 will be described later.

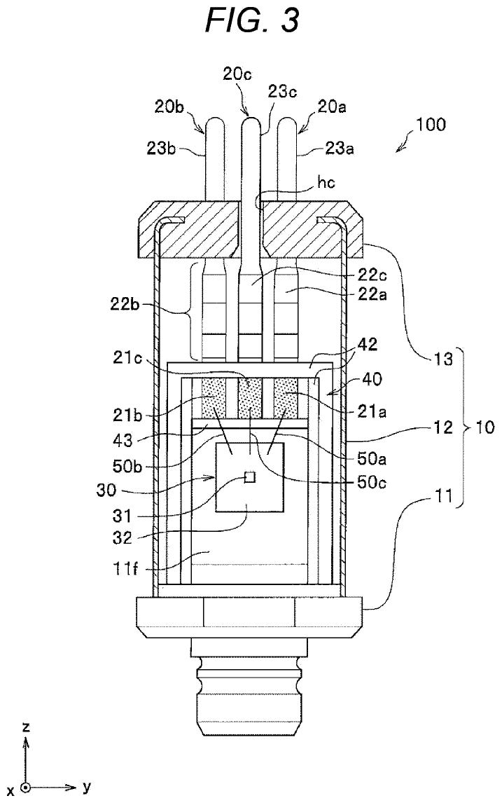

The terminals 20a, 20b, and 20c are terminals which electrically connect the sensor unit 30 (see FIG. 3) and the substrate (not illustrated), and part of which are exposed from the housing 10.

FIG. 1B is a plan view of the pressure detecting device 100.

As illustrated in FIG. 1B, an insertion hole ha is formed in the guide 13, and the terminal 20a is inserted in this insertion hole ha (the same applies to other insertion holes hb and hc, too). In addition, the three terminals 20a, 20b, and 20c are used for power supply, for grounding, and for electrical signal transmission.

FIG. 2 is a cross-sectional view taken along a II-II line arrow view in FIG. 1B.

The pressure detecting device 100 includes the above-described housing 10 and terminals 20a, 20b, and 20c, and, in addition, the sensor unit 30, a terminal base 40, and wires 50a, 50b, and 50c (bonding wires: see FIG. 3).

The pressure port 11 of the housing 10 is a member which is made of a metal and is provided with an introduction hole H to which the pressure medium is introduced, and includes a diaphragm 11f. The diaphragm 11f is a thin portion which is distorted (i.e., deformed) when a pressure receiving surface 11p receives the pressure of the pressure medium. As illustrated in FIG. 2, the pressure receiving surface 11p is provided on a wall surface of the introduction hole H. When the pressure acting on this pressure receiving surface 11p is higher, a strain amount of the diaphragm 11f is also greater.

In addition, the pressure port 11 is fixed by being caulked to a module (not illustrated) provided with a flow path (not illustrated) of the pressure medium. Furthermore, in a state where the pressure port 11 is fixed to the above-described module, the flow path of the pressure medium provided to this module and the introduction hole H of the pressure port 11 continue, so that the pressure medium is introduced to the introduction hole H.

The sensor unit 30 has a function of detecting the strain amount of the diaphragm 11f, and outputting this strain amount as an electrical signal. The sensor unit 30 is, for example, a semiconductor strain sensor and has a thin plate shape. As illustrated in FIG. 2, the sensor unit 30 is bonded to a surface of the diaphragm 11f on a side opposite to the pressure receiving surface 11p by using a bonding agent G. For example, a low-melting point glass can be used as this bonding agent G.

FIG. 3 is a cross-sectional view taken along a III-III line arrow view in FIG. 1B.

In addition, FIG. 3 illustrates a side surface of the lower side of the cover 12 instead of a cross section thereof.

Furthermore, FIG. 3 illustrates a connection portion 21a of the terminal 20a as a dot (the same applies to other connection portions 21b and 21c, too). Although described in detail later, the terminal 20a includes the connection portion 21a, a spring mechanism 22a, and a terminal portion 23a in order toward the outside of the housing 10 (z direction upper side), and these portions are integrally formed. In addition, the same applies to the other terminals 20b and 20c, too.

As illustrated in FIG. 3, the sensor unit 30 includes a strain detecting element 31 and a processing circuit 32.

The strain detecting element 31 is an element which detects a strain amount of the pressure receiving surface 11p (see FIG. 2) which is strained when receiving the pressure. Although not illustrated, the strain detecting element 31 includes a bridge circuit formed by establishing bridge-connection between a plurality of strain gauges. Furthermore, as the diaphragm 11f (see FIG. 2) is strained, a resistance value of the above-described bridge circuit changes.

The processing circuit 32 is a circuit which processes a signal from the strain detecting element 31, and includes a circuit which amplifies the above-described signal and a surge protection circuit although not illustrated. Furthermore, the strain detecting element 31 and the processing circuit 32 are mounted on a silicon substrate as one chip. Consequently, by mounting the strain detecting element 31 and the processing circuit 32 as one chip, it is possible to reduce the number of electrical connection points.

Back to FIG. 2, the description continues again.

The terminal base 40 is a member which is made of a resin and fixes relative positions of the pressure port 11 and the connection portion 21a (i.e., the connection portions 21a, 21b, and 21c in FIG. 3). As illustrated in FIG. 2, the terminal base 40 is interposed between the pressure port 11 and the connection portion 21a. In addition, the terminal base 40 is insert-molded together with these terminals 20a, 20b, and 20c in a state where the terminals 20a, 20b, and 20c are positioned.

As illustrated in FIG. 2, the terminal base 40 includes a base portion 41, a first fixing portion 42, and a second fixing portion 43.

The base portion 41 includes a recess portion J in which the pressure port 11 is fitted. In an assembly configuration of the pressure detecting device 100, the diaphragm 11f is exposed in a state where the pressure port 11 is fitted in the recess portion J, and the sensor unit 30 is installed on this diaphragm 11f (a surface on the opposite side to the pressure receiving surface 11p) with the bonding agent G interposed therebetween.

The first fixing portion 42 illustrated in FIG. 2 is a portion which fixes an upper side of the connection portion 21a (a side of a spring mechanism 22a). As illustrated in FIG. 3, the first fixing portion 42 has a reverse U shape in a side view, and is formed by integrally forming a portion which extends in a y direction and a portion which extends from both ends of this portion to a lower side. Furthermore, the portion which extends in the y direction of the first fixing portion 42 presses the upper sides of the connection portions 21a, 21b, and 21c (a side of spring mechanism 22a, 22b, and 22c).

In this regard, although not illustrated, a wall (a wall which is elongated in a z direction) of the base portion 41 illustrated in FIG. 2 and close to an inner wall surface of the cover 12 has an arc shape of a semicircular shape in a plan cross-sectional view, and is integrally formed with the first fixing portion 42 by insert-molding.

The second fixing portion 43 illustrated in FIG. 3 is a portion which fixes a lower side of the connection portion 21a (a side of the sensor unit 30), and extends in the y direction. This second fixing portion 43 presses the lower sides of the connection portions 21a, 21b, and 21c (the side of the sensor unit 30). In addition, the second fixing portion 43 is integrally formed with the base portion 41 and the first fixing portion 42 by insert-molding.

Thus, the upper sides of the connection portions 21a, 21b, and 21c are fixed by the first fixing portion 42, and the lower sides of the connection portions 21a, 21b, and 21c are fixed by the second fixing portion 43. Consequently, even when, for example, the spring mechanism 22a illustrated in FIG. 2 elastically deforms, the terminal 20a is strongly fixed at the connection portion 21a, so that there is no concern of an electrical connection failure.

The cover 12 illustrated in FIG. 2 is a member which is made of a metal and houses the sensor unit 30 together with the pressure port 11 and the guide 13, and has a cylindrical shape whose center axis is parallel to the z direction. A lower end of the cover 12 is welded or bonded to the pressure port 11, and a vicinity of an upper end of the cover 12 and the guide 13 are insert-molded.

The guide 13 is a member in which terminal portions 23a, 23b, and 23c are inserted, and has a thick disk shape. In the guide 13, the insertion hole ha in which the terminal portion 23a of the terminal 20a is inserted, an insertion hole hb (see FIG. 1B) in which the terminal portion 23b of the terminal 20b is inserted, and the insertion hole hc in which the terminal portion 23c of the terminal 20c is inserted are formed.

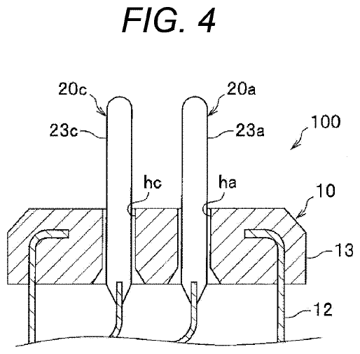

FIG. 4 is a partial enlarged view in a dashed-dotted line frame K in FIG. 2. As illustrated in FIG. 4, the diameter of the insertion hole ha is slightly larger than the diameter of the terminal portion 23a of the terminal 20a. That is, the insertion hole ha is formed so as not to block movement of the terminal portion 23a in the z direction (so as not to press-fit or lightly press-fit the terminal portion 23a in the insertion hole ha) accompanying elastic deformation of the spring mechanism 22a (see FIG. 2). In addition, the same applies to the other insertion holes hb and hc, too.

Furthermore, the insertion hole ha has a tapered shape, and is formed such that the diameter of the insertion hole ha becomes larger toward the inside of the housing 10. Consequently, it is easy to perform an operation of inserting the terminal portion 23a from the lower side of the insertion hole ha (the same applies to the other insertion holes hb and hc, too).

Next, although configurations of the terminals 20a, 20b, and 20c will be described, the configuration of the terminal 20a will be mainly described and description of the other terminals 20b and 20c employing the same configuration will be omitted.

The terminal 20a illustrated in FIG. 2 is a terminal which electrically connects the sensor unit 30 and the external substrate (not illustrated), and is connected to the sensor unit 30 with the wire 50a interposed therebetween. Furthermore, part of the terminal 20a is exposed retractably in the z direction from the housing 10.

As illustrated in FIG. 2, the terminal 20a includes the connection portion 21a, the spring mechanism 22a, and the terminal portion 23a which are integrally formed. The connection portion 21a is a portion which is connected to the sensor unit 30 with the wire 50a interposed therebetween, and has a plate shape. In an example illustrated in FIG. 2, a planar direction (yz plane) of the connection portion 21a is parallel to the planar direction of the sensor unit 30. Furthermore, the connection portion 21a is provided right above the sensor unit 30. Thus, the connection portion 21a and the sensor unit 30 are easily connected with the wire 50a interposed therebetween, so that it is possible to miniaturize the pressure detecting device 100.

The spring mechanism 22a is a portion which is elastically deformed by a downward pressing force which acts on the terminal portion 23a from this substrate when establishing contact connection with the external substrate (not illustrated), and is provided in the housing 10. In the example illustrated in FIG. 2, a leaf spring which is curved in a meandering shape in a vertical cross-sectional view is used as the spring mechanism 22a. In addition, a portion of the terminal 20a between the connection portion 21a and the spring mechanism 22a closely adheres to an upper surface of the terminal base 40 with a resin interposed therebetween.

The terminal portion 23a illustrated in FIG. 2 is a portion part of which is exposed from the housing 10 and establishes contact connection with the external substrate (not illustrated). The terminal portion 23a has a bar shape, and extends in the z direction continuing to the upper side of the spring mechanism 22a. Furthermore, when the pressing force from the above-described substrate elastically deforms the spring mechanism 22a, part of the terminal portion 23a retracts in the housing 10 (i.e., the length of the portion exposed from the housing 10 becomes short). When this pressing force is canceled, part of the terminal portion 23a returns to the original state. In addition, a distance between the upper surface of the guide 13 and the substrate is held by an unillustrated member.

The wire 50a is a wire which electrically connects the sensor unit 30 and the terminal 20a. For example, aluminum (Al) or gold (Au) can be used for this wire 50a.

The wire 50a has one end which is connected to the sensor unit 30 by, for example, wire bonding of a thermosonic method, and the other end which is connected to the connection portion 21a of the terminal 20a. More specifically, a wire bonder (not illustrated) which is a connection device applies ultrasonic vibration to the wire 50a in a state where a predetermined load is applied to the wire 50a to cause friction against and come into pressure contact with the wire 50a to electrically connect the wire 50a. In addition, the same applies to the wire 50b which connects the terminal 20b and the sensor unit 30, and the wire 50c which connects the terminal 20c and the sensor unit 30, too.

Furthermore, a back side of the connection portion 21a illustrated in FIG. 2 is substantially integrally formed with a wall of the terminal base 40, and the back side of this wall is adhered to the pressure port 11 by an adhesive. That is, there is no gap between the connection portion 21a, the wall of the terminal base 40, and the pressure port 11 in an x direction, and the thickness in the x direction is sufficiently secured (the same applies to the other connection portions 21b and 21c, too). Consequently, during processing of wire bonding and in a state where the pressure port 11 is fixed, it is possible to appropriately apply the predetermined load and the ultrasonic vibration to the wire 50a.

In addition, the above-described thermosonic method is one example of wire bonding, and other known methods (thermocompression method) may be applied. Next, a configuration for adhering the pressure port 11 and the terminal base 40 directly below the connection portions 21a, 21b, and 21c in the x direction will be described.

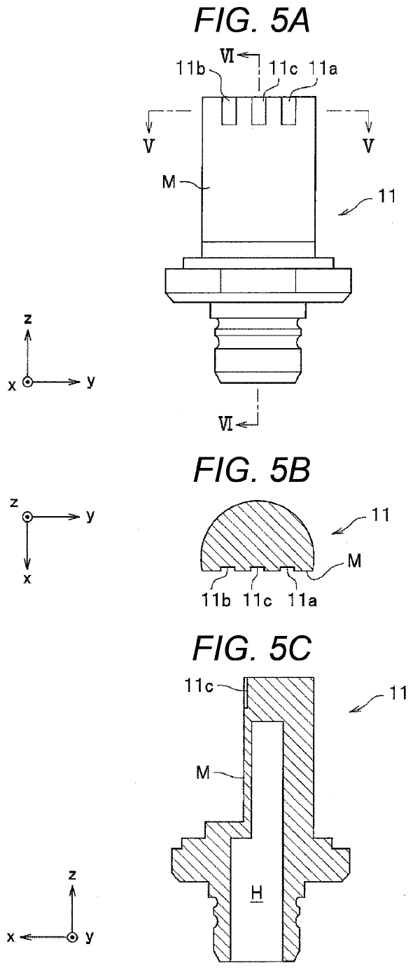

FIG. 5A is a side view of the pressure port 11. As illustrated in FIG. 5A, grooves 11a, 11b, and 11c (recess portions) having rectangular shapes in the side view are formed near the upper end of the pressure port 11.

FIG. 5B is an end surface view taken along a V-V line arrow view in FIG. 5A. As illustrated in FIG. 5B, an upper portion of the pressure port 11 has a shape formed by cutting part of a column on the yz plane. Furthermore, portions which are recessed toward an x direction negative side are formed as the grooves 11a, 11b, and 11c near an upper end of a side surface M having a planar shape. In this regard, by taking into account the amount and viscosity of the adhesive to be applied to the groove 11a, an area in the side view (see FIG. 5A) of the groove 11a and the depth in a plan cross-sectional view (see FIG. 5B) are determined.

FIG. 5C is a cross-sectional view taken along a VI-VI line arrow view in FIG. 5A. As illustrated in FIG. 5C, the groove 11c is formed up to the upper end of the pressure port 11. That is, the groove 11c to which the adhesive for adhering the pressure port 11 and the terminal base 40 is applied is formed at a portion of the pressure port 11 meeting the connection portion 21c in the x direction. In other words, the connection portion 21c (see FIG. 2), the wall of the terminal base 40 (see FIG. 2), and the groove 11c of the pressure port 11 overlap in the x direction (the same applies to the other grooves 11a and 11b, too). Furthermore, in a state where the adhesive is applied to these grooves 11a, 11b, and 11c, and the pressure port 11 is adhered to the terminal base 40, the adhesive is thermally cured. Consequently, it is possible to prevent formation of the gap directly below the connection portion 21c in the x direction, and appropriately perform wire bonding in a state where the pressure port 11 is fixed.

In addition, if a configuration without the grooves 11a, 11b, and 11c is employed, the adhesive applied to the side surface M is likely to unnecessarily get wet and widen, or drop due to the gravity in a state where the pressure port 11 is vertically disposed (a state where the pressure port 11 is placed in a direction illustrated in FIG. 5C). As a result, the amount of adhesive is likely to vary between products of the pressure detecting devices 100, and reliability of wire bonding lowers.

By contrast with this, according to the first embodiment, the grooves 11a, 11b, and 11c are formed near the upper end of the pressure port 11, so that the amount of adhesive to be applied to these grooves 11a, 11b, and 11c becomes substantially fixed. Consequently, the amount of adhesive hardly varies between the products of the pressure detecting devices 100, and it is possible to appropriately perform wire bonding as described above.

<Effect>

According to the first embodiment, part of the terminal 20a is exposed from the housing 10, and, as the spring mechanism 22a elastically deforms, a distal end portion of the terminal 20a retracts. That is, the terminal 20a and the cover 12 are not intentionally insert-molded, so that the terminal 20a is retractable (movable in upper and lower directions) via the insertion hole ha. Consequently, it is possible to appropriately electrically connect the terminal 20a and the substrate (not illustrated) by an elastic force of the spring mechanism 22a without using a connector harness (not illustrated) which is another part.

Furthermore, as illustrated in FIG. 2, there is employed a relatively simple configuration where the sensor unit 30, the wire 50a, and the terminal 20a are electrically connected, so that it is possible to substantially reduce the number of connection points and the number of parts compared to the conventional technique. More specifically, electrical connection portions are only the one ends and the other ends of the wires 50a, 50b, and 50c in the pressure detecting device 100. In this way, the number of electrical connection points is small, so that there is no concern that a failure such as a connection failure occurs, and it is possible to provide the reliable pressure detecting device 100.

Furthermore, the parts related to electrical connection are the sensor unit 30, the wires 50a, 50b, and 50c, and the terminals 20a, 20b, and 20c, and the number of parts is relatively small. Consequently, it is possible to reduce manufacturing cost compared to a configuration where multiple parts are provided as in above-described PTL 1.

Furthermore, the first fixing portion 42 and the second fixing portion 43 press the connection portion 21a. Consequently, even when the pressing force from the substrate (not illustrated) elastically deforms the spring mechanism 22a, there is no concern that a connection failure occurs at the connection portion 21a, and it is possible to enhance reliability of the pressure detecting device 100.

### Second Embodiment

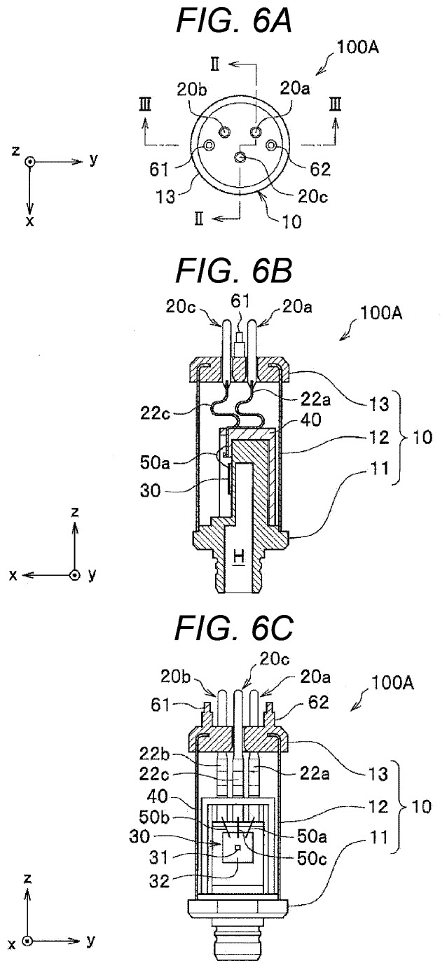

The second embodiment differs from the first embodiment in providing protrusion portions 61 and 62 which protrude from a guide 13 (see FIG. 6C) to an upper side. However, the other points are the same as those of the first embodiment. Hence, portions different from those of the first embodiment will be described, and description of overlapping portions will be omitted.

FIG. 6A is a plan view of a pressure detecting device 100A according to the second embodiment. The pressure detecting device 100A includes a housing 10, terminals 20a, 20b, and 20c, and the protrusion portions 61 and 62 illustrated in FIG. 6A, and, in addition, a sensor unit 30 (see FIG. 6B), a terminal base 40 (see FIG. 6B), and a wire 50a (see FIG. 6B). As described above, features of the pressure detecting device 100A according to the second embodiment include that the protrusion portions 61 and 62 are provided.

FIG. 6B is a cross-sectional view taken along a II-II line arrow view in FIG. 6A. As illustrated in FIG. 6B, the protrusion portion 61 protrudes from the guide 13 of the housing 10 to the upper side, and is integrally molded with this guide 13 (the same applies to the other protrusion portion 62, too: see FIG. 6C).

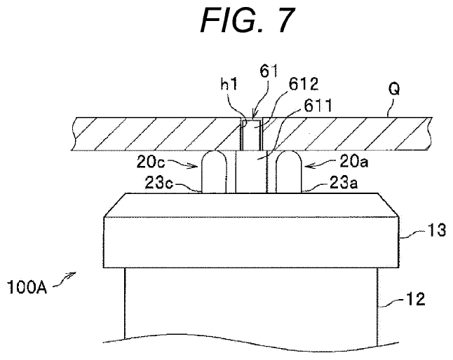

FIG. 6C is a cross-sectional view taken along a III-III line arrow view in FIG. 6A. An elastic force of a spring mechanism 22a places the protrusion portions 61 and 62 illustrated in FIG. 6C in contact with an external substrate Q in a state where the terminal 20a and this substrate Q (see FIG. 7) are electrically connected.

FIG. 7 is an explanatory view illustrating a state where the pressure detecting device 100A is electrically connected with the substrate Q. As illustrated in FIG. 7, the protrusion portion 61 employs a configuration where a first columnar portion 611 of a columnar shape extending from the guide 13 to the upper side, and a second columnar portion 612 of a columnar shape extending from this first columnar portion 611 to the upper side are integrally molded.

The first columnar portion 611 has a larger diameter than that of a through-hole h1 (hole) formed in the external substrate Q, and comes into contact with this substrate Q in a state where the elastic force of the spring mechanism 22a electrically connects the terminal 20a and the substrate Q.

In addition, the length in an axial direction of the first columnar portion 611 is determined such that the elastic force of the spring mechanism 22a applies a predetermined contact load between the terminal 20a and the substrate Q in a state where the first columnar portion 611 is in contact with the substrate Q. Consequently, even when a load acting on the first columnar portion 611 from the substrate Q differs per type of a device on which the substrate Q is disposed, it is possible to fixedly keep the contact load between the terminal 20a and the substrate Q.

The second columnar portion 612 has a smaller diameter than that of the through-hole h1 (hole) formed in the substrate Q. Furthermore, in a state where the first columnar portion 611 is in contact with the substrate Q, the second columnar portion 612 is surrounded by the through-hole h1 (hole) of the substrate Q. By providing this second columnar portion 612, it is easy to position the pressure detecting device 100A with respect to the substrate Q. In addition, the other protrusion portion 62 (see FIG. 6C) employs the same configuration as that of the above-described protrusion portion 61, and therefore description thereof will be omitted.

### <Effect>

According to the second embodiment, it is possible to fixedly keep the retracting length of the terminal portion 23a in the housing 10 in a state where the first columnar portion 611 is in contact with the substrate Q. Consequently, even when the type of the device on which the substrate Q is installed differs as described above, it is possible to fixedly keep the contact load of the terminal 20a and the substrate Q. Furthermore, the protrusion portions 61 and 62 have functions, too, which position the terminal 20a with respect to the substrate Q, so that it is possible to further enhance electrical connection reliability compared to the first embodiment.

### <<Modification>>

Pressure detecting devices 100 and 100A according to the present invention have been described above based on each embodiment. However, the present invention is not limited to these descriptions, and can be variously changed. For example, each embodiment has described a configuration where spring mechanisms 22a, 22b, and 22c are leaf springs. However, other types of springs (e.g., coil springs) may be used.

Furthermore, each embodiment has described a configuration where a sensor unit 30 and terminals 20a, 20b, and 20c are electrically connected by wire bonding, yet is not limited to this. For example, a flexible printed circuit board may be used instead of wire boding.

Furthermore, each embodiment has described a configuration where elastic forces of the spring mechanisms 22a, 22b, and 22c establish contact connection between the terminals 20a, 20b, and 20c and a substrate, yet is not limited to this. That is, the terminals 20a, 20b, and 20c and the substrate may be electrically connected by soldering.

Furthermore, each embodiment has described a configuration where three grooves 11a, 11b, and 11c (see FIG. 5B) are formed near an upper end of a pressure port 11, and an adhesive is applied to these grooves 11a, 11b, and 11c, yet is not limited to this. For example, one wide groove may be formed in an x direction or a predetermined number of grooves which are two or more may be formed. That is, at least one groove may be formed at a portion of the pressure port 11 meeting a connection portion 21a. Furthermore, the groove does not need to reach the upper end of the pressure port 11 (see FIG. 5C), and the adhesive may be applied to a predetermined recess portion.

Furthermore, each embodiment has described a case where a base portion 41, a first fixing portion 42, and a second fixing portion 43 of a terminal base 40 are integrally formed, yet is not limited to this. That is, the base portion 41, the first fixing portion 42, and the second fixing portion 43 may be separate portions, and may be rigidly connected (welded or screwed).

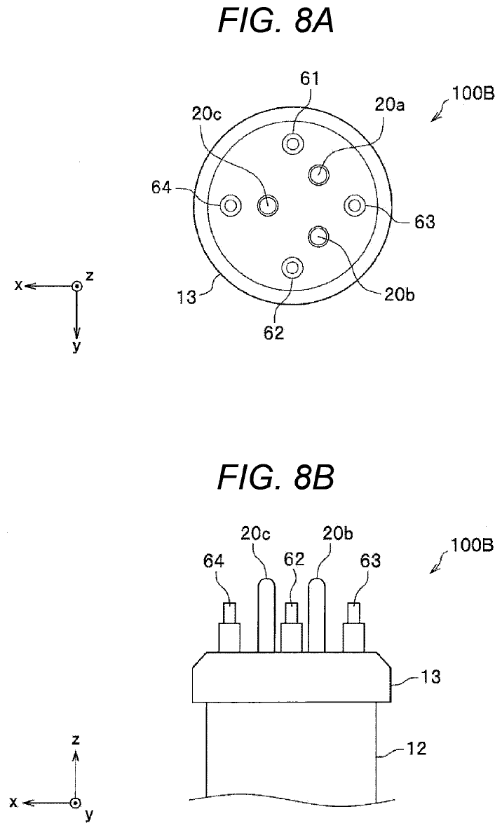

Furthermore, the second embodiment has described the configuration where two protrusion portions 61 and 62 (see FIG. 6C) are formed in a housing 10, yet is not limited to this. For example, four protrusion portions 61 to 64 (see FIG. 8A) may be formed as described below.

FIG. 8A is a plan view of a pressure detecting device 100B according to the modification, and FIG. 8B is a side view of an upper portion of this pressure detecting device 100B. As illustrated in FIGS. 8A and 8B, the four protrusion portions 61 to 64 are formed in a guide 13, and four through-holes (not illustrated) may be formed in a substrate (not illustrated), too, to meet the four protrusion portions 61 to 64.

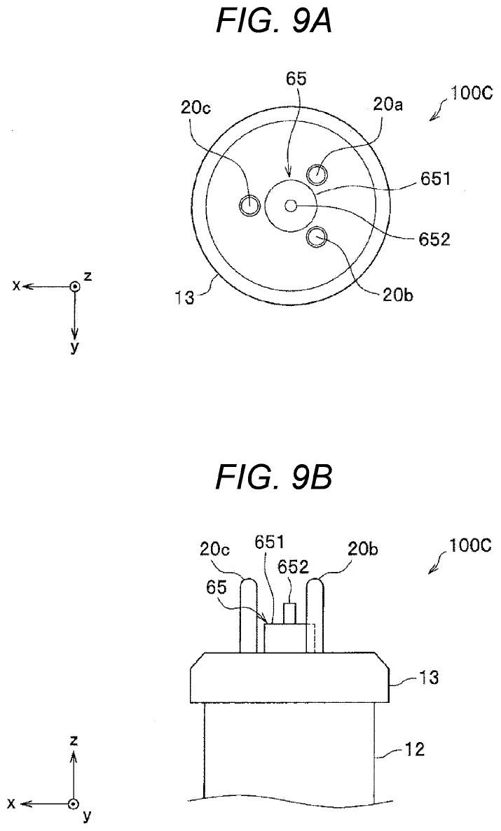

FIG. 9A is a plan view of a pressure detecting device 100C according to another modification, and FIG. 8B is a side view of an upper portion of this pressure detecting device 100C. As illustrated in FIGS. 9A and 9B, one protrusion portion 65 is formed in the guide 13, and one through-hole (not illustrated) may be formed in a substrate (not illustrated), too, to meet the one protrusion portion 65. Furthermore, as illustrated in FIG. 9A, a first columnar portion 651 is provided near the center of the guide 13 in the plan view, and it is desirable to make an area of a planar cross section of the first columnar portion 651 relatively large. Consequently, it is easy to position the first columnar portion 651 in a state where the first columnar portion 651 is in contact with the substrate.

In addition, the number of protrusion portions formed in the guide 13 may be three or may be five or more. That is, there may be employed a configuration including at least one protrusion portion.

Furthermore, the second embodiment has described a configuration where a first columnar portion 611 and a second columnar portion 612 of the protrusion portion 61 have columnar shapes, yet is not limited to this. That is, the first columnar portion 611 and the second columnar portion 612 may have elliptic cylindrical shapes or may have polygonal shape.

Furthermore, each embodiment has described the case where the pressure detecting devices 100 and 100A are used to detect a brake hydraulic pressure of an automobile, yet is not limited to this. By using, for example, the pressure detecting device 100, it is possible to detect a pressure of a fuel gas of the automobile. Furthermore, the pressure detecting device 100 is applicable to automobiles and, in addition, various devices such as railway vehicles, airplanes, and home appliances.

Furthermore, each embodiment has been described in detail for ease of description of the present invention, and is not necessarily limited to those including all described components. Furthermore, as part of the components of the embodiments, the other components can be added, deleted, or replaced. Furthermore, the above-described mechanisms and components which are considered to be necessary for description have been described, and do not necessarily indicate all mechanisms and components in terms of products.

### REFERENCE SIGNS LIST

100, 100A, 100B, 100C pressure detecting device
10 housing
11 pressure port
11a, 11b, 11c groove (recess portion)
11f diaphragm
11p pressure receiving surface
12 cover
13 guide
20a, 20b, 20c terminal
21a, 21b, 21c connection portion
22a, 22b, 22c spring mechanism
23a, 23b, 23c terminal portion
30 sensor unit
31 strain detecting element
32 processing circuit
40 terminal base
41 base portion
42 first fixing portion
43 second fixing portion
50a, 50b, 50c wire
61, 62, 63, 64, 65 protrusion portion
611, 621, 651 first columnar portion
612, 622, 652 second columnar portion
G bonding agent
H introduction hole
Q substrate
h1 through-hole (hole)
ha, hb, hc insertion hole

1. A pressure detecting device comprising:
a sensor unit which includes a strain detecting element which detects a strain amount of a pressure receiving surface strained when receiving a pressure, and a processing circuit which processes a signal from the strain detecting element;
a housing which houses the sensor unit; and
a terminal which is connected to the sensor unit and part of which is exposed retractably from the housing,
wherein the terminal includes a spring mechanism which is provided in the housing and can elastically deform.

2. The pressure detecting device according to claim 1, wherein, in the housing, an insertion hole in which the terminal is inserted has a tapered shape, and a diameter of the insertion hole is formed to become larger toward an inside of the housing.

3. The pressure detecting device according to claim 1, wherein the terminal includes a connection portion which is connected to the sensor unit via a bonding wire.

4. The pressure detecting device according to claim 3, wherein
the housing includes a pressure port which is provided with an introduction hole to which a pressure medium having the pressure is introduced, and
includes a terminal base which is interposed between the pressure port and the connection portion, and fixes relative positions of the pressure port and the connection portion,
the pressure receiving surface is provided on a wall surface of the introduction hole, and
a recess portion is formed at a portion of the pressure port meeting the connection portion, and an adhesive which adheres the pressure port and the terminal base is applied to the recess portion.

5. The pressure detecting device according to claim 3, wherein
the terminal includes the connection portion, the spring mechanism, and a terminal portion in order toward an outside of the housing, and part of the terminal portion is exposed retractably from the housing, and
the housing includes
a first fixing portion which fixes the connection portion on a side of the spring mechanism, and
a second fixing portion which fixes the connection portion on a side of the sensor unit.

6. The pressure detecting device according to claim 1, further comprising at least one protrusion portion which protrudes from the housing,
wherein the protrusion portion comes into contact with the substrate in a state where an elastic force of the spring mechanism electrically connects the terminal and an external substrate.

7. The pressure detecting device according to claim 6, wherein the protrusion portion is formed by integrally molding
a first columnar portion whose diameter is larger than that of a hole formed in the substrate, and which comes into contact with the substrate in a state where the elastic force of the spring mechanism electrically connects the terminal and the substrate, and
a second columnar portion whose diameter is smaller than that of the hole of the substrate and which is surrounded by the hole in a state where the first columnar portion is in contact with the substrate.
